(19) United States
(12) Patent Application Publication
(10) Pub. No.: US 2026/0105308 A1
(43) Pub. Date: Apr. 16, 2026

(54) Network Traffic Prediction Method

(71) Applicant: Neueda Technologies Ireland Limited, Athlone (IE)

(72) Inventor: Mohamed Ibrahim, Letterkenny (IE)

(21) Appl. No.: 19/470,295

(22) PCT Filed: Mar. 27, 2024
(86) PCT No.: PCT/EP2024/058383

§ 371 Date: Sep. 29, 2025

(30) Foreign Application Priority Data
Mar. 27, 2023 (GB) 2304470.4

(51) Int. Cl. G06N 3/082; G06N 3/042; G06N 3/0442

(52) U.S. Cl. CPC G06N 3/082; G06N 3/042; G06N 3/0442

(57) ABSTRACT

A method of training a hybrid neural network to predict network traffic load within a telecommunications network, the hybrid neural network comprising a graph convolutional neural network layer and a recurrent neural network layer, the method comprising: receiving network topology data relating to the telecommunications network, the network topology data comprising spatiotemporal features of the telecommunications network; receiving time series network log data of traffic loads within the telecommunications network; modelling the telecommunications network as a graph network, the graph network encoding the network topology data as graph network data; training the hybrid neural network using the graph network data and time series network log data; outputting a trained hybrid neural network for network traffic load prediction.

### TECHNICAL FIELD

The present disclosure relates to a network traffic prediction method. Aspects of the invention relate to a method of training a hybrid neural network to predict network traffic load within a telecommunications network, a method for predicting network traffic load within a telecommunications network and a network component within a telecommunications network.

### BACKGROUND

A cellular network is a communications network, where the network is distributed over a land area that is split into smaller areas known as cells. Each cell includes a fixed location transceiver known as a base station, and when joined together, these cells are able to communicate across a wide geographic area. Predicting cellular traffic on the network is extremely important for optimising network operations, and often Artificial Intelligence (AI) or Machine Learning (ML) models are used for this. However, there are currently limitations of these models, particularly when considering efficiency, scalability, and integration with a 5G network.

5G technology is supported by a new type of network, which moves from the traditional closed networks to an open one: an Open Radio Access Network (O-RAN). O-RAN is an industry wide standard for RAN interfaces, providing an interoperability standard for RAN elements such as antenna, radios, and base units. This architecture offers increased interoperability between equipment, and thus increased flexibility, at a lower cost. Cellular traffic prediction models have to be able to integrate with this new network architecture.

Recent 5G and O-RAN standards from telecommunications standards bodies (3GPP) mean that decoupling, or separation, of hardware and software elements is necessary for a 5G network. This is a central concept of O-RAN, where the traditional hardware-centric RAN is disaggregated into three primary building blocks: open radio units (O-RU); open distributed units (O-DU); and open central units (O-CU). These blocks are interconnected by open and standardised interfaces and managed by RAN intelligent controllers (RICs) in the cloud.

As cellular technology evolves, the amount of cellular traffic on networks has increased significantly. Accurate methods of predicting cellular traffic are therefore extremely important to proactively manage and achieve optimal operation of the network. It is useful to predict various parameters, for example, the maximum throughput, the total size of the downloaded and uploaded data packets per second, and the size and arrival times of individual data packets. Accurately predicting these parameters allows the network to change its operation to handle upcoming traffic. For example, a network prediction model allows a network to effectively allocate network resources, manage task scheduling, turn base stations off when the cellular traffic is below a certain threshold (base station sleeping), and perform admission control (a check performed before establishing a connection to determine if the current resources are sufficient for the proposed connection). As discussed briefly above, AI and ML models are often used for this purpose, and indeed, the O-RAN architecture embraces AI models to optimise network operations.

Various AI- and ML-based frameworks have been developed to predict base station traffic loads ahead of time. Many of the frameworks are univariant, and model only the temporal features of the base-station network logs. While useful information, some of the key features of the network, such as handover between base stations, and the number of connected users, are lost when using this type of framework. It is important to include these features and indeed, some existing frameworks are multi-variant and do take these features into account. However, many of the current univariant and multivariant frameworks are designed to integrate with an individual base station, and not over the entire network. Significant computing resources are therefore required for the training and inference tasks, and scaling these frameworks across an entire network is extremely challenging. Additionally, since these models are associated with an individual base station, they are unable to capture spatiotemporal features of the network, such as handover patterns between base stations. Also, the existing models may not be capable of integrating with the new 5G centralised architecture.

US2022110021 describes one method for predicting cellular traffic load in a certain geographical area. The method first identifies in-motion vehicular cellular devices moving in the area using a plurality of network infrastructure apparatuses (for example, base stations). A trained ML model is then used to predict the future cellular traffic load for the infrastructure apparatuses based on an estimated future location of the vehicular cellular devices and their predicted cellular data consumption. The future cellular traffic load is then provided to a cellular traffic management system, which may take a proactive measure based on the predicted future cellular traffic load. While this model can predict traffic flow at an individual base station, it is subject to the limitations discussed above, as the localised deployment on each individual base station fails to capture the intercorrelation features of the network topology, and makes it unable to integrate with the new 5G technology. Additionally, scaling this method is likely to present various challenges.

WO2021242151 also describes a system and method for traffic flow prediction in a wireless network based on heavy-hitter encoding. Heavy hitter encoding predicts network traffic by identifying the most frequent or “heavy-hitting” flows. This process involves monitoring traffic at various points in the network, using sampling techniques to identify heavy hitters, and encoding and storing them in a data structure for further analysis and prediction. More specifically, the computer-implemented method described in WO2021242151 comprises collecting training data comprising Internet Protocol (IP) addresses extracted from packets for a plurality of traffic flows in a wireless network, and one or more actual traffic type related parameter for each of the traffic flows. Heavy-hitter IP address encodings, based on the extracted IP addresses, are trained and then used to encode the extracted IP addresses. Finally, a traffic type predictor of a traffic flow predictor is trained based on the encoded IP addresses and the one or more actual traffic type related parameters for each of the traffic flows. A drawback of this method is that the application of heavy-hitter encoding in 5G networks may not be efficient. 5G networks have a higher capacity and bandwidth, which results in a large number of possible heavy hitters. This makes it challenging to identify the most crucial traffic flows, and leads to a high number of false positives. Additionally, 5G networks have a high degree of network slicing, which makes the traffic flows highly dynamic and complex to predict using heavy-hitter encoding. This network slicing, alongside the fact that 5G networks involve a high degree of virtualization, also makes it harder to identify the sources of heavy hitters. Finally, the new 5G networks introduce new types of traffic, such as URLLC and mMTC, that may not be well suited for prediction using heavy-hitter encoding.

CN114039871 describes a method for predicting cellular traffic flow, where the method first acquires cellular traffic data, and then extracts features from this data from 3 perspectives (global spatial, global temporal, and local spatial-temporal). Cellular traffic flow is then predicted using the extracted features. In more detail, an attention mechanism is used to obtain node-level and trend-level global spatial correlation of different cellular flow units, and then the global spatial correlation of these two levels is fused. The attention mechanism is then used to obtain global temporal correlation of the data of the same cellular flow unit at different historical moments. A convolution operation then continuously captures the local spatial-temporal correlation. The method therefore comprehensively captures the space-time correlation of the cellular flow, and so can effectively model space-time characteristics of the cellular flow. A disadvantage of this method however, is that the computational cost of the model is high due to the attention mechanisms used, and because it requires iterative convolution operations.

CN114158085A describes another method of predicting cellular traffic, and uses a spatiotemporal aggregation graph convolutional network. Firstly, an area is divided into a plurality of sub-regions, where each sub-region is a network node. Daily historical patterns and hourly current patterns of cellular mobile traffic are modelled to capture spatiotemporal correlations of cellular traffic across all nodes at different times, and a graph convolutional network learns the features of each node. The outputs of the K layers of the aggregation graph convolutional network module are then connected through an embedded module, and prediction information is fused with external features extracted by an external module, and the outputs of the two models are then combined to obtain the input to a regression module, through which a mobile traffic prediction result is obtained. Model parameters are then updated to obtain a minimum loss function, and the final mobile cellular traffic prediction result. The limitation of this technique however is that temporal dependencies of the network traffic data is not considered in the prediction model.

An objective of the current invention is therefore to provide an AI or ML model that can integrate with the new 5G architecture, and perform cellular traffic analysis and load predictions for thousands of connected O-RUs within the 5G network.

### SUMMARY OF THE INVENTION

According to a first aspect of the present invention there is provided a method of training a hybrid neural network to predict network traffic load within a telecommunications network, the hybrid neural network including a graph convolutional neural network layer and a recurrent neural network layer, the method including: receiving network topology data relating to the telecommunications network, the network topology data including spatiotemporal features of the telecommunications network; receiving time series network log data of traffic loads within the telecommunications network; modelling the telecommunications network as a graph network, the graph network encoding the network topology data as graph network data; training the hybrid neural network using the graph network data and the time series network log data; and outputting a trained hybrid neural network for network traffic load prediction.

The present invention provides for a hybrid neural network comprising a graph convolutional neural network layer and a recurrent neural network layer (such as a Long short-term memory (LSTM) neural network). The method comprises receiving network topology data such as the geographical location of bass stations in the telecommunications network, the azimuth of each cell in the base stations, the antenna heights of base stations etc. Time series network log data in the form of historical network logs are also received.

The hybrid nature of the neural network is suited to predicting cellular network traffic as the GCN layers are designed to learn the spatiotemporal correlation between the different sites in a cellular network, while the recurrent neural network (e.g. LSTM) layers then learn the time series periodic pattern, for example seasonality or stationery of the traffic loads. The hybrid neural network improves the time series prediction efficiency of the resultant trained network traffic load predictor.

The hybrid neural network may be configured such that outputs from the graph convolutional neural network layer are used as inputs to the recurrent neural network layer.

The network topology data may comprise site coordinates of network sites within the telecommunication network and modelling the telecommunications network includes, for each site within the telecommunications network, transforming site coordinates into a graph node and defining a graph edge for any neighbouring pair of sites that are interconnected.

Modelling the telecommunications network may comprise encoding historical time series network log data for each site as a node feature.

Modelling the telecommunications network may comprise weighting graph edges by geographical distance between neighbouring sites and number of handover occurrences.

Modelling the cellular network into a graph network and embedding the network logs as graph features improves the prediction performance, as the model efficiently encodes the inter-correlated spatiotemporal features of the cellular network.

Training the hybrid neural network may comprise generating a temporal graph, gₜ, from the graph network data and time series network log data.

Training may comprise: splitting gₜ into training and evaluation sets, training the model with the training set, evaluating hybrid neural network performance with the evaluation set and optimising hybrid neural network performance, e.g. by changing hyperparameters, until the hybrid neural network performance exceeds an accuracy threshold.

Optimising hybrid neural network performance may comprise one or more of: changing a number of layers in the graph convolutional network; changing a number of layers in the recurrent neural network; changing a number of neurons in one or more layers of either the graph convolutional network and/or the recurrent neural network; changing activation functions using within the hybrid neural network. It is noted that the number of layers and the prediction window are linked to the evaluation of the framework and the desired level of accuracy

The hybrid neural network may comprise one or more reshaping layers and/or dropout layers.

The recurrent neural network may comprise a Long short-term memory (LSTM) neural network.

According to a second aspect of the present invention there is provided a method for predicting network traffic load within a telecommunications network including: receiving network data logs including traffic data relating to telecommunications traffic within the telecommunications network; predicting network traffic load according to said network data logs wherein predicting comprises providing the network data logs as inputs to a traffic predictor using a trained hybrid neural network that has been trained according to the method of the first aspect of the present invention, wherein the trained hybrid neural network provides predicted network traffic loads within the telecommunications network.

The method may comprise setting a required prediction window for which predicted network traffic load is required; checking the prediction window that the trained hybrid neural network has been trained for and, in the event that the required prediction window differs from the trained prediction window, retraining the hybrid neural network according to the method of the first aspect of the present invention with the required prediction window.

The method may comprise adaptively setting the prediction window in dependence on a predefined accuracy threshold.

According to a third aspect of the present invention there is provided a network component within a telecommunications network including a trained hybrid neural network that has been trained according to the first aspect of the present invention.

According to a further aspect of the invention there is provided a Radio Access Network (RAN) intelligent controller comprising a network component according to the third aspect of the invention. Being compatible with a RAN intelligent controller is advantageous as it means that the invention is compliant with the O-RAN standardisation and capable of integrating with new 5G telecommunications architecture. Additionally, the RAN intelligent controller is in the O-cloud, where there are enough computing resources for periodic training and inference of the hybrid neural network. The network component including a trained hybrid neural network is also designed as a centralised component, and so can easily scale with the telecommunications network topology.

The present invention extends to a computer program comprising instructions which, when the program is executed by a computer, cause the computer to carry out the method of the first or second aspects of the present invention. The present invention also extends to a computer-readable medium comprising instructions which, when executed by a computer, cause the computer to carry out the first or second aspects of the present invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination.

That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is an overview of the architecture of a telecommunications network and shows schematically the process of generating a traffic load predictor according to an embodiment of the present invention;

FIG. 2 is an overview of an Open Radio Access Network (O-RAN) architecture incorporating a traffic load prediction framework in accordance with an embodiment of the present invention;

FIG. 3 shows a schematic block diagram illustrating the traffic load prediction framework of FIG. 2 in greater detail;

FIG. 4 shows details of a graph transformation algorithm that is used to perform the graph transform process of FIG. 1;

FIG. 5 shows examples of graph networks obtained using the graph transformation algorithm of FIG. 4;

FIG. 6 shows details of a training algorithm that is used to perform the model training, validation, and hyperparameter optimisation processes of FIG. 3;

FIG. 7 shows schematically an example of the default hybrid neural network model architecture that can be used to create the network prediction framework in accordance with an embodiment of the present invention;

FIG. 8 shows example plots of the training and validation loss and training and validation mean square error obtained from the model validation process of FIG. 3;

FIG. 9 shows two example plots of traffic prediction obtained using the hybrid neural network according to an embodiment of the present invention.

### DETAILED DESCRIPTION

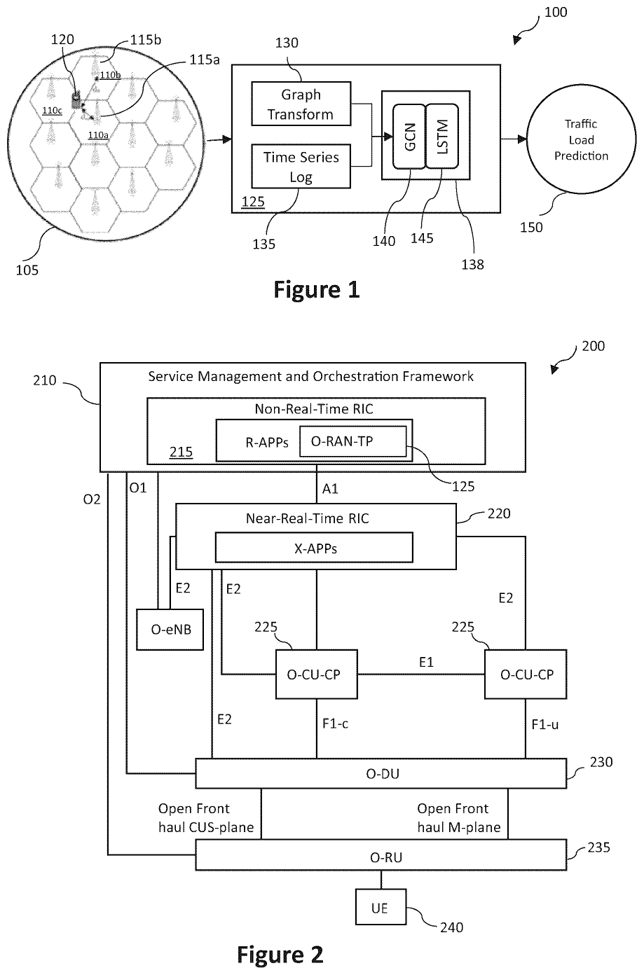

A method of training a hybrid neural network to predict network traffic load in a telecommunications network and a method of predicting network traffic load in accordance with embodiments of the present invention are described below in relation to FIGS. 1 to 9.

FIG. 1 shows an overview of the architecture of a telecommunications network 105 and the process 125 of generating a traffic load predictor 150, in the form of a hybrid neural network, in accordance with embodiments of the present invention. The telecommunications network 105 is shown as comprising a number of network cells 110, each cell containing a base station 115. A telecommunications device 120 is shown at the junction of three network cells 110a, 110b, 110c and connected to a first base station 115a in cell 110a and second base station 115b in cell 110b. The telecommunications device is therefore shown in a handover state as it moves between the cells 110a and 110b.

FIG. 1 also illustrates schematically the process, or framework, 125 for generating a traffic load predictor 150. The framework 125 comprises 2 parts: the first relating to producing training data, and the second relating to creating and training a model for traffic load prediction. The training data comprises a graph modelling/transformation process 130, and a time series log 135. The input to the graph transform 130 and the time series log 135 is data from the telecommunications network 105. The graph transform 130 and time series log 135 are then used as inputs to the second part of the framework 125, which comprises a process for training and creating a traffic load prediction model. The traffic load prediction model 150 is referred to as a hybrid GCN/LSTM model, as it comprises two types of neural network: a graph convolutional neural network (GCN) 140 and a long short-term memory (LSTM) neural network 145. As described in more detail below, the training of the GCN/LSTM model 138 results in a traffic load prediction module 150 according to embodiments of the present invention.

Turning to FIG. 2, an Open Radio Access Network (O-RAN) architecture incorporating a traffic load prediction framework 125 in accordance with embodiments of the present invention is shown within a RAN network 200. The network 200 comprises several entities including a service management and orchestration (SMO) framework 210, an O-RAN intelligent controller (RIC) 215, 220, open central units (O-CUs) 225, an open distributed unit (O-DU) 230, an open radio unit (O-RU) 235, and an open evolved Node B (O-eNB) 240 (the hardware element of the network 200). The entities are able to communicate with each other through various communication channels, with the specific functions of some of these entities discussed in more detail below.

In general, O-RAN architecture disaggregates hardware and software elements, separating them into distinct layers with interfaces between them to allow for integration of equipment from different vendors. O-RAN elements are designed as virtualised software-based components that can be deployed on an O-Cloud, which is a cloud computing platform that provides flexible, scalable infrastructure and computing resources for the different components of the O-RAN.

A key component of O-RAN architecture is the O-RAN intelligent controller (RIC) 215,220. The RIC is responsible for providing centralised control and management of the RAN functions in the disaggregated and virtualised RAN network 200. The RIC 215,220 enables the management of resources across different RAN functions and vendors, and enables the dynamic allocation of resources based on network conditions and service requirements.

There are 2 primary components of the RIC: the non-real-time RIC (N-RIC) 215 and the real-time RIC (RT-RIC) 220. The N-RIC 215 is responsible for managing the configuration and orchestration of non-real-time RAN functions such as radio resource management, mobility management, and security management, and enables network operators to perform high-level management and orchestration tasks. The RT-RIC 220 however is responsible for managing the real-time control and optimisation of RAN functions such as radio resource management, interference management, and beamforming, in order to ensure the best user experience. The RT-RIC 220 is typically deployed at the edge of the network, close to the O-DU 230 and O-RU 235. This ensures low latency and efficient communication. The N-RIC 215 however can be deployed in a central location, such as a data centre or regional cloud. The N-RIC 215 and RT-RIC 220 work together to provide a comprehensive and flexible network 200 management and control solution

The RIC (both the RT-RIC and N-RIC) 215, 220 is designed to work in conjunction with other key O-RAN components, such as the O-CU 225 and the O-DU 230. The O-CU 225 is a virtualised, software-based element that can be deployed and scaled on the O-Cloud, and is responsible for managing the control plane functions of the O-RAN. Control plane functions include tasks such as managing the configuration and control of the O-DU 230 and O-RU 235, as well as monitoring their performance and coordinating the communication between them. The O-CU 225 also provides the interface for communication with other network elements, such as the RIC 215.

The O-DU 230 is responsible for the physical layer processing of the wireless signal, such as modulation, demodulation, and channel coding. The O-DU 230 is typically located close to the antenna at the individual base stations, and is responsible for interfacing with the O-RU 235 and the O-CU 225 to manage the wireless link. It typically contains digital signal processors and other specialized hardware to perform these functions.

The O-RU 235 is responsible for the physical layer of wireless communication, and is responsible for connectivity to the end user. The O-RU 235 is located at the individual base station, and connects to the O-DU 230 over a fronthaul interface, which is typically an Ethernet link. The O-RU 235 is responsible for tasks such as modulation, demodulation, and RF signal processing. The O-RU 235 is designed to be software-defined and programmable, which allows for flexibility in the implementation of different radio access technologies and the ability to adapt to changing network conditions.

The proposed framework 125 for predicting cellular traffic load is a centralised framework, designed to be hosted on the non-real time RIC 215 in the O-cloud, where there are enough computing resources for periodic training and inference of the GCN/LSTM model 138 within the framework 125. The centralised nature of the proposed framework 125 means it is capable of integrating with the new 5G architecture, and makes it compliant with O-RAN standardisation. The framework 125 can also scale easily with the network topology. The framework 125 is designed to be virtualised and deployed as docker containers, which provide a portable way to package and deploy software. The containers allow for flexible scaling as they are easily replicated and deployed on different machines/environments. Additionally, the SMO framework 210 can automatically scale the number of replicas of the containerized framework 125 based on demand, making it easy to handle changes in traffic or load. The framework 125 is also designed to leverage the hidden interconnected relations between the network sites to improve the prediction performance.

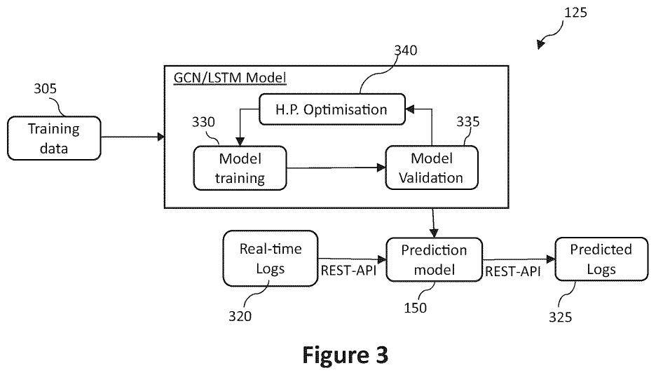

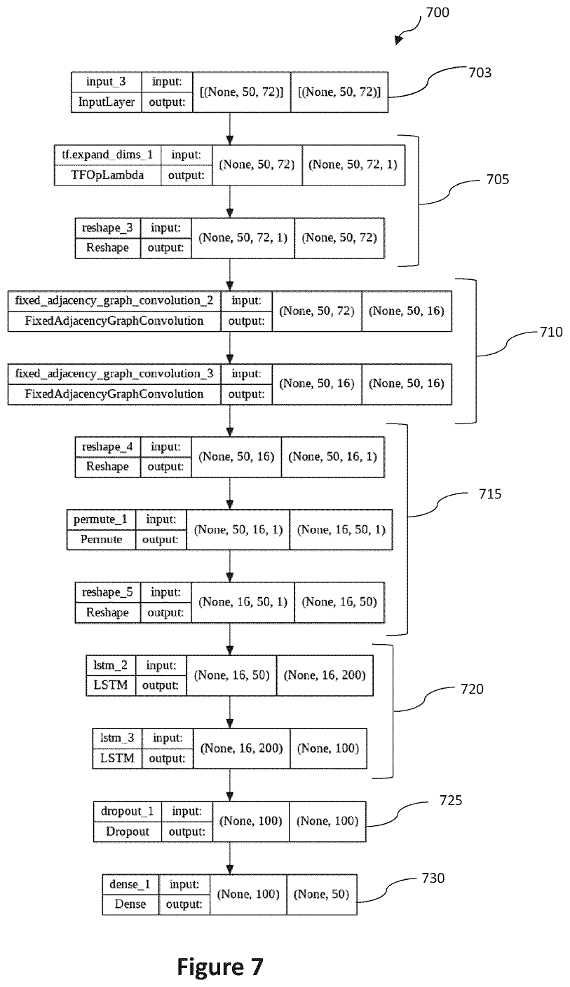

The traffic load prediction framework 125 according to embodiments of the present invention is illustrated schematically in greater detail in FIG. 3. Firstly, training data 305, in the form of graph network data 130 (derived from the network topology) and time series network log data 135, is generated and input to the GCN/LSTM hybrid neural network/model 138, which comprises a model training module 330, a model validation module 335, and a hyperparameter optimisation module 340. These modules 330, 335, 340 operate in a loop. The training data 305 trains the model 330, and the model validation module 335 continuously evaluates model accuracy. If the model accuracy is not above a certain threshold pre-determined by the network operator, the hyper-parameter optimisation module 340 is configured to change the hyper-parameters of the model to achieve better accuracy. Hyper-parameters may comprise, for example, the number of CGN or LSTM layers in the hybrid neural network 138 being trained, or the type of activation function used within various layers of the model. The optimisation process and hyper-parameters will be discussed later in more detail with reference to FIG. 7. The model training 330, model validation 335, and hyper-parameter optimisation 340 process is configured to repeat until the model validation module 335 determines that the model accuracy is greater than the threshold, and so the model is optimised. Model validation 335 is carried out using mean square errors and total training loss. It should be noted that the training process occurs ‘offline’using the training data 305 until the model is optimised.

The trained model as determined by the model validation module 335 is output from the GCN/LSTM model 138 and becomes the traffic load prediction model 150, which can be used to predict cellular traffic load. In order to predict cellular traffic load, real-time network logs 320 are input to the prediction model 150, and the prediction model 150 outputs a network traffic prediction in the form of predicted logs 325 for the network. The predicted logs 325 may undergo further processing for visualisation purposes. Over time, the GCN-LSTM model 138 undergoes continuous training and validation, as the real-time data logs 320 used for prediction purposes are aggregated with the historical training data 305, and a replicated model is trained and evaluated using the newly arrived data.

The real-time network logs 320 are network logs comprising information relating to the cellular traffic at each base station 115 in the cellular network 105, and the predicted logs 325 are the predicted cellular traffic load at each base station 115. The predicted logs 325 can be used by the network to effectively manage network resources.

As discussed briefly above and illustrated in FIG. 1, the traffic prediction framework 125 according to the present invention comprises two stages: generating the training data, and creating and training the GCN/LSTM hybrid neural network/model 138 for cellular traffic prediction. The training data 305 comprises two components: the graph transform data 130 and time series network log data 135. The graph transform data 130 is obtained by a process that transforms the cellular network topology 105 into a graph network that encodes temporal, spatiotemporal and dynamic features. Temporal log data from temporal logs of the base stations are dynamically embedded in the graph network using node and edge features, and as such time series data is captured.

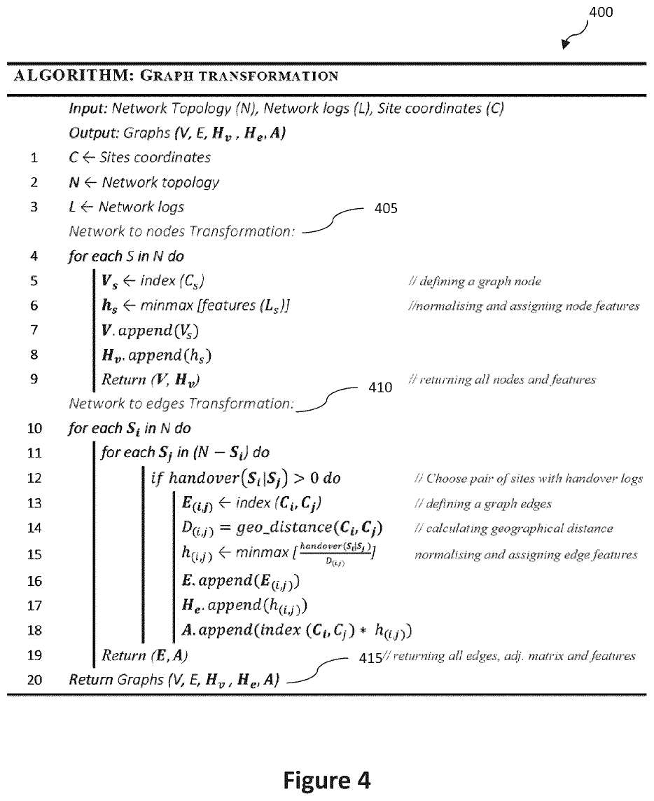

To obtain the graph transform data 130, a graph transformation algorithm 400 is used. This algorithm 400 is described in detail in FIG. 4, and shows the steps required to transform the network topology, including site coordinates of the particular base stations and network logs of those base stations, into a graph network that includes all the network base stations in a chosen area. As shown in FIG. 4, the inputs to the graph transformation algorithm 400 are the Network Topology N (relating to the arrangements of elements in the telecommunications network), Network Logs L (the time series network logs 135), and the Site Coordinates C of the different network sites S.

Firstly, a network to nodes transformation is carried out at Step 405. The algorithm 400 transforms the coordinates of each site in the network cluster, for example the geographical coordinates of each base station 115a, 115b, 115c, into a set of graph nodes V, each node Vᵢ representing a site location. Each site's historical traffic load is encoded as a node feature Hᵥ. Optionally, to improve the encoded node features, the algorithm 400 may include other parameters, such as the numbers and types of connected users and the running services, for example video streaming and voice calls.

After all nodes V and node features Hᵥ are returned by the algorithm 400, a network to edges transformation is performed at Step 410. Based on the site profile and the azimuth of the local antennas, the algorithm 400 defines the edges E connecting the graph nodes, where each edge Eᵢ connecting a pair of nodes represents two neighbouring base stations with interconnecting air interfaces. The algorithm 400 weights the graph edges by the geographical distance between the base stations and the number of handover occurrences between each pair of nodes. An adjacency matrix A is then generated that defines all connected nodes, and defines the weight of these connections as edge features H_{E}. For computing optimisation, the algorithm 400 normalises all the node features Hᵥ and edge features H_{E} to values between 0 and 1. The graph network is then returned at Step 415. This graph network provides the graph network data 130 and the time series data 135, the two components of the training data 305 for the GCN/LSTM model 138.

As outlined, the graph is geometrically modelled based on the network topology. The the network logs (time series data) are embedded into the graph as nodes and edges. The whole graph, with its features that dynamically change over time, is used for training and validation of the GCN/LSTM model. Once trained the model is used to predict cellular traffic loads: the real-time network logs 320 are embedded into the same constructed graph, and the model outputs the predicted logs 325.

Modelling the cellular network into a graph network and embedding the network logs as graph features improves the prediction performance, as the model efficiently encodes the inter-correlated spatiotemporal features of the cellular network.

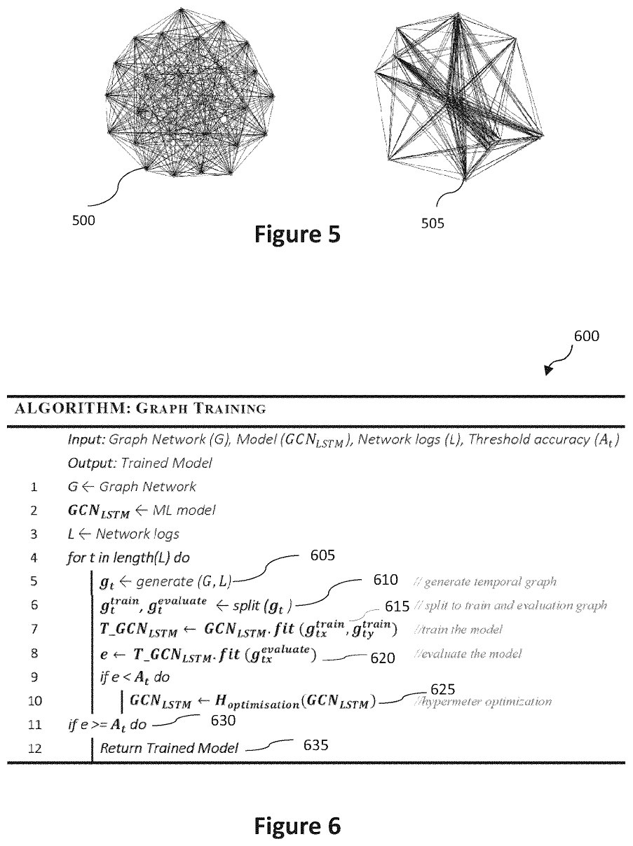

FIG. 5 shows two examples of returned graph networks obtained using the described graph transformation algorithm 400. The first graph network 500 shows the graph network obtained when the handover and traffic exchange between two neighbouring base stations is not taken into account, and thus the graph edges are not weighted. The second graph network 505 however shows an example of a graph network obtained when the graph edges have been weighted to account for these features. The two graphs illustrated therefore show the importance of taking the handover traffic between base stations into account when creating a graph network.

After the training data 305 has been generated, the second stage of the proposed framework 125 for creating and training a traffic load predictor 150 comprises training the GCN/LSTM model. This training process was illustrated schematically in FIG. 3, and the GCN-LSTM training algorithm 600 that is used to perform this process is outlined in detail in FIG. 6.

As described in FIG. 6, there are various inputs for the GCN-LSTM training algorithm 600: the graph network G that was obtained using the graph transformation algorithm 400, a default GCN/LSTM model GCN_{LSTM}, network logs L and a threshold accuracy Aₜ. The default GCN/LSTM model GCN_{LSTM} is the non-optimised model that is initially fed with training data, and the threshold accuracy Aₜ is a chosen value above which the model is deemed to be sufficiently accurate.

Firstly, a temporal graph gₜ, is generated at Step 605 from the graph network data G and the network log data L. The temporal graph gₜ is then split into a training graph gₜ^{train} and an evaluation graph gₜ^{eval} at Step 610. The training graph gₜ^{train} is used to train the model GCN_{LSTM} at Step 615, and the evaluation graph gₜ^{eval} is used to evaluate the trained model GCN_{LSTM} at Step 620. If the model evaluation value e is found to be less than the threshold accuracy Aₜ, the GCN-LSTM training algorithm 600 changes the hyper-parameters of the model at Step 625. This process of evaluation and hyper-parameter optimisation is repeated until the evaluation value e is greater than the threshold accuracy Aₜ. When the model evaluation value e is greater than or equal to the threshold accuracy Aₜ, the GCN-LSTM training algorithm 600 returns the trained hybrid neural network/model 138 at Step 635. In this way, the GCN/LSTM model for predicting cellular traffic load is created.

The GCN/LSTM model of the framework 125 integrates a hybrid machine-learning model 138 composed of stacked layers of graph convolutional networks (GCN) 140 and long short-term memory (LSTM) neural networks 145. The combination of the two types of neural networks is particularly suited to this application (i.e. the prediction of cellular network traffic), as the GCN layers are designed to learn the spatiotemporal correlation between the different sites in a cellular network, such as handover patterns, which reflect the dynamic change of the required services. The LSTM layers then learn the time series periodic pattern, for example seasonality or stationery of the traffic loads. Seasonality refers to the presence of regular and predictable patterns in the time series data that recur at specific intervals, such as daily, weekly, or annually. Stationarity is when the statistical properties of the time series data, such as the mean and variance, remain constant over time. A stationary time series is one that does not have a trend or seasonality. Providing a hybrid neural network 138 in which a graph convolutional network 140 is combined with a LSTM model 145 improves the time series prediction efficiency of the resultant trained network traffic load predictor, as the framework 125 can predict the upcoming traffic of the entire network cluster in less than 100 milliseconds.

FIG. 7 illustrates in detail an embodiment of the default CGN/LSTM model architecture 700 for the network load prediction framework 125. It is noted that FIG. 7 represents one example of a default architecture and as discussed later the default architecture may comprise different numbers of stacked layers depending on the specifics of the use case that the trained network traffic load predictor 150 is going to be used with.

The example default architecture 700 of an untrained CGN/LSTM model 138 comprises several stacked layers including an input layer 703, 2 reshaping layers 705, 2 graph convolution layers 710, 3 subsequent reshaping layers 715, 2 LSTM layers 720, a dropout layer 725, and a dense layer 730.

The input to the default model architecture 700 is a large dataset containing all the information on spatiotemporal (relating to the network configuration expressed as a graph network data) and time series data (relating to network log data). The input data is first fed into the GCN, where spatiotemporal features are learned, and this output is then processed and fed into the LSTM, which learns the time series data.

The training data 305 is fed into the default model architecture 700, and the first two reshaping layers 705 pre-process this training data 305. The two layers of graph convolution 710 are trained using the training data gₜ^{train} and validated using the evaluation data gₜ^{eval}, and so the spatiotemporal features of the input data are learned. The output of the graph convolution layers 710 then gets reshaped through the three subsequent reshaping layers 715. The output of the subsequent reshaping layers 715 is fed into the two LSTM layers 720 for the model to learn the temporal features of the time series data. Similar to in the GCN layers 710, gₜ^{train} is used to train the LSTM model layers, and gₜ^{eval} is used to validate the trained LSTM model layers. Finally, the dropout layer 725 and then the dense layer 730 processes the output data. The output is the trained model 150 that can be used to predict cellular traffic load.

Input data 305 is in the form of an array, for example 50×72. It should be noted that ‘none’ in the input and output matrices refers to the batch size, which is the number of training examples in one forward and backward pass of the training data. In this instance ‘none’ is used to mean ‘not-fixed’, and thus any batch size can be used. The input data is a certain size, and the reshaping layers 705 pre-process the input data 305 prior to it being input to the graph convolution layers 710. The first re-shaping layer ensures that the inputs have the correct shape for the fixed adjacency matrix A, and normalises the matrix by weighting the importance of the edges in the graph. The second reshaping layer reshapes the input data back to its original shape, for input into the graph convolution layers 710. The subsequent reshaping layers 715 reshape the output data from the GCN layers 710, (None, 50, 16), in order to feed it into a different type of layer, LSTM, which is made up of 200 neurons. The data is therefore reshaped to (None, 50, 200). The dropout layer 725 is a mask that nullifies the contribution of some neurons towards the next layer. For example, the dropout may be set equal to 0.5, which would set the value of 50% of neurons to 0 through the training to avoid model overfitting The dense layer 730 is used in the final stages of the neural network, to change the dimensionality of the output from the preceding layer.

It should be appreciated that FIG. 7 illustrates the default CGN/LSTM model architecture. However, as the model is trained, the integrated optimisation process changes various hyper-parameters in order to achieve the most accurate model. For example, the number of layers in each section (reshaping, LSTM, GCN etc) and the number of neurons in each layer can be considered to be changeable hyper-parameters, which can be adapted and changed throughout the validation process in order to obtain the most accurate model. The prediction window, from predicting days ahead to hours, can also be adapted based on the accuracy rate. The prediction window refers to the length of time into the future for which the model is forecasting. In the traffic prediction framework 125, the length of the prediction window can be set adaptively based on the continued evaluation and the desired level of forecasting accuracy. It is important to note that the size of the prediction window will affect the accuracy of the framework 125. For example, a larger prediction window requires more historical data for the model to learn from, and makes the model more sensitive to errors and outliers, which in turn affects the accuracy of the predictions. The prediction window can be varied to give a maximum prediction window for a few days or can be limited to a few hours based on user demands. For example, if the model should be trained to predict a few minutes ahead, the model can be made up of a single layer of GCN and a single layer of LSTM instead of two of each, and the number of neurons in each layer can be adaptively reduced. However, if the same model architecture is used to predict a few hours instead, the accuracy will be degraded. By performing hyper-parameter optimisation, the number and size of layers will increase to meet the required threshold accuracy Aₜ. The integrated optimisation process also chooses the best learning rate, the training drop-out ratio, and the most effective optimisation and activation functions in order to obtain the most accurate traffic prediction model. The training process of the framework 125 is also designed to be automated based on a pre-defined schedule, or whenever the accuracy level declines based on continuous evaluation of the inference model.

After training and evaluation of the model, a docker image is built to be deployed and run on the cluster. Using a docker image to containerise the framework 125 will provide several advantages. A primary advantages is portability, as containers package the model and its dependencies together, making it easy to deploy the model on any O-Cloud infrastructure that supports the container runtime. This allows for more efficient and predictable deployment of the model, as it ensures that the model will run the same way in different environments. Moreover, containerising the framework 125 allows for scaling and managing resources. The framework 125 can be easily scaled up or down to handle changes in workloads, allowing for better resource utilisation and cost savings. Also, containerising the framework 125 will provide a level of isolation from the host operating system, making it more secure and easier to manage dependencies and avoid conflicts. In conclusion, this improves the overall stability, security, and reliability of the framework 125 in production. The framework also integrates rest-API, which enables it to integrate with other services.

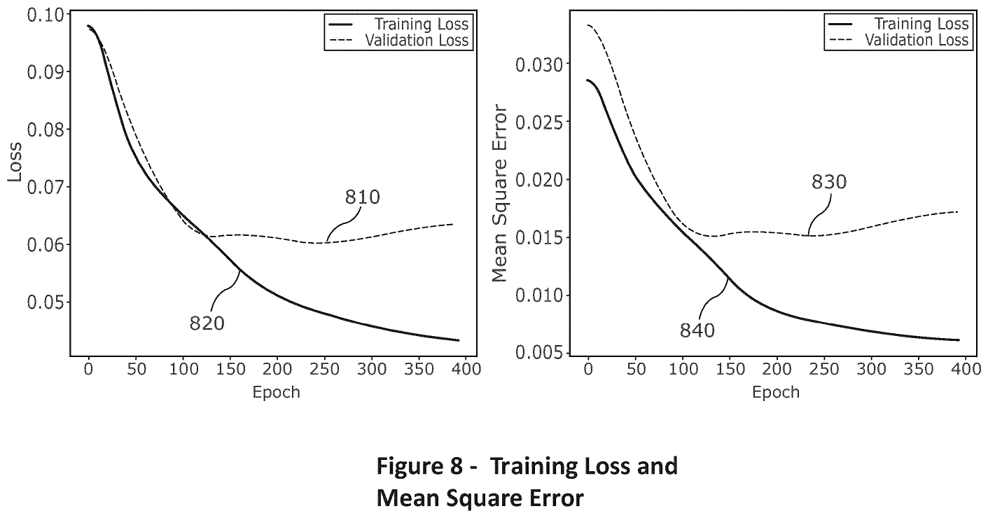

FIG. 8 is provided as an example of the training loss and mean square error (MSE) obtained from a model training and validation process. Training loss and MSE are often used together to determine how well a model performs during and after training. In general, the training loss evaluates a model's error on the training set, and is the average difference between the model's predicted output and the actual output of the training data. The smaller the training loss, the more accurately a model 138 fits the data. As illustrated in FIG. 8, both the training loss 810 and the validation loss 820 for the model 138 are low, less than 0.1, indicating a model that is able to fit the training data 305 and perform within an acceptable limit. FIG. 8 also shows that the loss during the training process utilising a variable number of epochs (400 epochs in the figure) continues to decrease until convergence.

The MSE meanwhile measures the overall performance of the model 138. The MSE is the average squared difference between the anticipated output of the model 138 and the actual output of test data. FIG. 8 shows that both the training MSE 830 and the validation MSE 840 are low, again indicating an effective model for predicting cellular traffic.

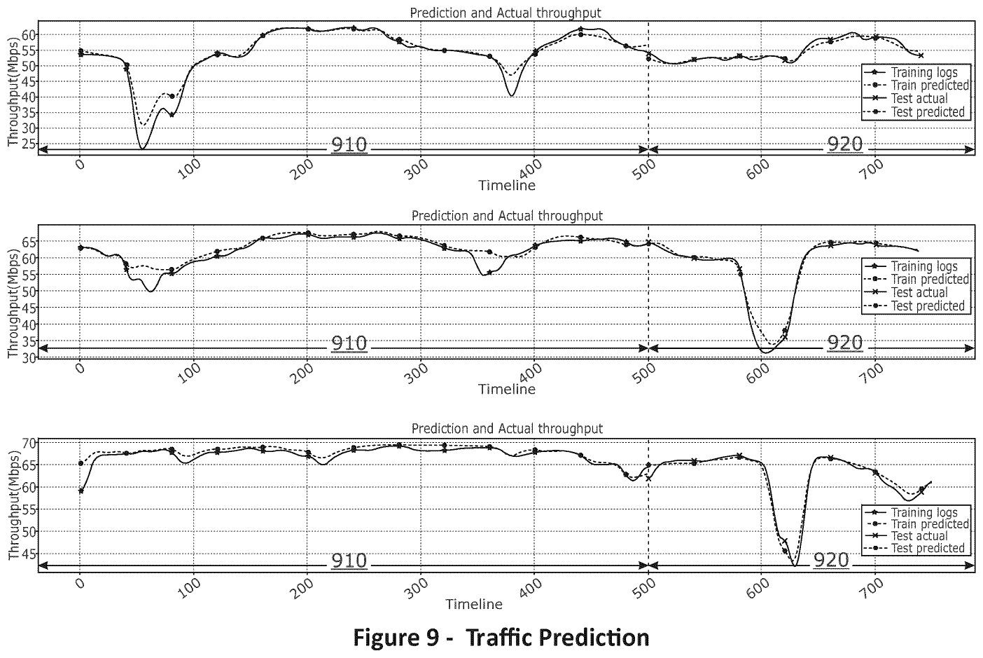

FIG. 9 shows three examples of traffic prediction using the above described method. The first part 810 of the chart shows the training data and the real data plotted over time. The training data is used to train the model, and the real data is used to evaluate the model's performance through the training process. Thus, the chart shows how well the model is able to fit the training data and how accurately it predicts the real data. The second part 820 of the chart shows the forecasted data and the real data, plotted over time. The forecasted data is generated by the trained model using historical data as input. The similarity between the forecasted data and the real data indicates how well the model predicts future network traffic patterns based on historical data.

It will be appreciated that various changes and modifications can be made to the present invention without departing from the scope of the present application.

1. A method of training a hybrid neural network to predict network traffic load within a telecommunications network, the hybrid neural network comprising a graph convolutional neural network layer and a recurrent neural network layer, the method comprising:
receiving network topology data relating to the telecommunications network, the network topology data comprising spatiotemporal features of the telecommunications network;
receiving time series network log data of traffic loads within the telecommunications network;
modelling the telecommunications network as a graph network, the graph network encoding the network topology data as graph network data;
training the hybrid neural network using the graph network data and the time series network log data; and
outputting a trained hybrid neural network for network traffic load prediction.

2. A method as claimed in claim 1, wherein the hybrid neural network is configured such that outputs from the graph convolutional neural network layer are used as inputs to the recurrent neural network layer.

3. A method as claimed in claim 1, wherein the network topology data comprises site coordinates of network sites within the telecommunication network and modelling the telecommunications network comprises, for each site within the telecommunications network, transforming site coordinates into a graph node and defining a graph edge for any neighbouring pair of sites that are interconnected.

4. A method as claimed in claim 3, wherein modelling the telecommunications network comprises encoding historical time series network log data for each site as a node feature.

5. A method as claimed in claim 3, wherein modelling the telecommunications network comprises weighting graph edges by geographical distance between neighbouring sites and number of handover occurrences.

6. A method as claimed in claim 1, wherein training the hybrid neural network comprises generating a temporal graph, gₜ, from the graph network data and time series network log data.

7. A method as claimed in claim 6, wherein training comprises: splitting gₜ into training and evaluation sets, training the model with the training set, evaluating hybrid neural network performance with the evaluation set and optimising hybrid neural network performance until the hybrid neural network performance exceeds an accuracy threshold.

8. A method as claimed in claim 7, wherein optimising hybrid neural network performance comprises one or more of: changing a number of layers in the graph convolutional network; changing a number of layers in the recurrent neural network; changing a number of neurons in one or more layers of either the graph convolutional network and/or the recurrent neural network; changing activation functions using within the hybrid neural network.

9. A method as claimed in claim 1, wherein the hybrid neural network comprises one or more reshaping layers and/or dropout layers.

10. A method as claimed in claim 1, wherein the recurrent neural network comprises a Long short-term memory (LSTM) neural network.

11. A method for predicting network traffic load within a telecommunications network comprising:
receiving network data logs comprising traffic data relating to telecommunications traffic within the telecommunications network;
predicting network traffic load according to said network data logs; and
providing the network data logs as inputs to a traffic predictor using a trained hybrid neural network; and
predicting network traffic load according to the traffic predictor,
wherein the trained hybrid neural network has been trained to provide the predicted network traffic loads within the telecommunications network by:
receiving network topology data relating to the telecommunications network, the network topology data comprising spatiotemporal features of the telecommunications network;
receiving time series network log data of traffic loads within the telecommunications network;
modelling the telecommunications network as a graph network, the graph network encoding the network topology data as graph network data; and
training the hybrid neural network using the graph network data and the time series network log data.

12. A method as claimed in claim 11, further comprising:
setting a required prediction window for which predicted network traffic load is required;
checking the prediction window that the trained hybrid neural network has been trained for; and,
in the event that the required prediction window differs from the trained prediction window, retraining the hybrid neural network with the required prediction window.

13. A method as claimed in claim 12, further comprising:
adaptively setting the prediction window in dependence on a predefined accuracy threshold.

14. A network component within a telecommunications network comprising a hybrid neural network that includes a graph convolutional neural network layer and a recurrent neural network layer, the hybrid neural network configured to:
receive network topology data relating to the telecommunications network, the network topology data comprising spatiotemporal features of the telecommunications network;
receive time series network log data of traffic loads within the telecommunications network;
model the telecommunications network as a graph network, the graph network encoding the network topology data as graph network data;
train the hybrid neural network using the graph network data and the time series network log data; and
output a trained hybrid neural network for network traffic load prediction.

15. The network component according to claim 14, wherein the network component is part of a Radio Access Network (RAN) intelligent controller.

16. The network component according to claim 14, wherein to train the hybrid neural network comprises to generate a temporal graph, gt, from the graph network data and the time series network log data.

17. The network component according to claim 15, wherein to train the hybrid neural network comprises to split gt into training and evaluation sets and train the model with the training set.

18. The network component according to claim 17, wherein to train the hybrid neural network further comprises to evaluate hybrid neural network performance with the evaluation set and optimise hybrid neural network performance until the hybrid neural network performance exceeds an accuracy threshold.

19. The network component according to claim 18, wherein to optimise hybrid neural network performance comprises one or more of changing a number of layers in the graph convolutional network and changing a number of layers in the recurrent neural network.

20. The network component according to claim 18, wherein to optimise hybrid neural network performance comprises one or more of changing a number of neurons in one or more layers of either the graph convolutional network and/or the recurrent neural network and changing activation functions using within the hybrid neural network.
